(19) United States
(12) Patent Application Publication
(10) Pub. No.: US 2014/0351546 A1
(43) Pub. Date: Nov. 27, 2014

(54) METHOD AND APPARATUS FOR MAPPING A PHYSICAL MEMORY HAVING A PLURALITY OF MEMORY REGIONS

(71) Applicant: ATI Technologies ULC, Markham (CA)

(72) Inventors: Yury Lichmanov, Richmond Hill (CA); Guennadi Riguer, Thornhill (CA)

(73) Assignee: ATI Technologies ULC, Markham (CA)

(21) Appl. No.: 13/901,690

(22) Filed: May 24, 2013

(51) Int. Cl. G06F 12/02

(52) U.S. Cl. CPC G06F 12/0284
USPC 711/170

(57) ABSTRACT

A method and apparatus are described for mapping a physical memory having different memory regions. A plurality of virtual non-uniform memory access (NUMA) nodes may be defined in system memory to represent memory segments of various performance characteristics. Memory segments of a high-bandwidth memory (HBM) system memory may be allocated to a first memory region of the physical memory having memory segments represented by a first one of the NUMA nodes. The physical memory may include a second memory region having memory segments represented by a second one of the NUMA nodes. Memory segments of system memory may be allocated to the second memory region. The physical memory may further include a third memory region having memory segments represented by a third one of the NUMA nodes. Memory segments of an interleaved uniform memory access (UMA) graphics memory may be allocated to the third memory region.

### TECHNICAL FIELD

The disclosed embodiments are generally directed to methods defined for heterogenous memory topology discovery and software controls for selecting memory affinity in uniprocessor and symmetrical multiprocessing (SMP) systems with heterogeneous memory configurations.

### BACKGROUND

In systems with multiple memory segments, (e.g., single or dual channel memory, high-bandwidth memory (HBM), and the like), of different performance characteristics, (i.e., heterogeneous memory configurations), it may be desirable to implement a locality-aware memory allocation mechanism to achieve maximum performance. There are some mechanisms for explicit memory locality controls for a graphic processing unit (GPU) video memory, but there are no such controls for a system memory of a central processing unit (CPU) or other processing devices. The performance implications of using an incorrect memory segment may be even more pronounced in heterogeneous system architecture (HSA) and accelerated processing unit (APU) graphics cases.

Non-uniform memory access (NUMA) based solutions for controlling memory allocation locality in systems with multiple CPUs/processing nodes have been implemented in the past. Further, there are some solutions for explicit selection of video memory segments for GPUs. However, solutions do not currently exist for managing system memory allocation affinity in systems with multiple memory segments.

### SUMMARY OF EMBODIMENTS

Some embodiments provide a method and apparatus for mapping a physical memory having different memory regions. A plurality of virtual non-uniform memory access (NUMA) nodes may be defined in system memory to represent memory segments of various performance characteristics. Memory segments of a high-bandwidth memory (HBM) system memory may be allocated to a first memory region of the physical memory having memory segments represented by a first one of the NUMA nodes. The physical memory may include a second memory region having memory segments represented by a second one of the NUMA nodes. Memory segments of system memory may be allocated to the second memory region. The physical memory may further include a third memory region having memory segments represented by a third one of the NUMA nodes. Memory segments of an interleaved uniform memory access (UMA) graphics memory may be allocated to the third memory region.

Some embodiments may provide a non-transitory computer-readable storage medium that may be configured to store a set of instructions that, when executed by at least one processor, perform a portion of a process to fabricate an integrated circuit (IC). The IC may include a plurality of virtual NUMA nodes configured to represent memory segments of various performance characteristics. The IC may further include a first memory region having memory segments represented by a first one of the NUMA nodes. A plurality of memory segments of an HBM system memory may be allocated to the first memory region of the physical memory. The IC may further include a second memory region having memory segments represented by a second one of the NUMA nodes. Memory segments of system memory may be allocated to the second memory region. The IC may further include a third memory region having memory segments represented by a third one of the NUMA nodes. The memory segments of an interleaved UMA graphics memory may be allocated to the third memory region. The instructions may be Verilog data instructions, hardware description language (HDL) instructions, or software or firmware instructions.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 shows an example of a symmetric memory that may be incorporated into an interleaving scheme in accordance with some embodiments;

FIG. 3 shows an example of an asymmetric memory without a uniform memory access (UMA) that may be incorporated into an interleaving scheme in accordance with some embodiments;

FIG. 4 shows an example of an asymmetric memory with a UMA below a MMIO hole that may be incorporated into an interleaving scheme in accordance with some embodiments;

FIG. 5 shows an example of an asymmetric memory with a UMA above a MMIO hole that may be incorporated into an interleaving scheme in accordance with some embodiments;

FIG. 6 shows an example of a system memory in accordance with some embodiments; and

FIG. 7 shows an example of a hybrid system memory in accordance with some embodiments.

### DETAILED DESCRIPTION OF EMBODIMENTS

Embodiments are described for controlling memory allocation affinity for CPUs and other processing devices in uniprocessor or SMP systems with heterogeneous memory configurations. A generic NUMA-like mechanism and application programming interfaces (APIs) may be used in SMP systems with multiple memory segments of different performance characteristics.

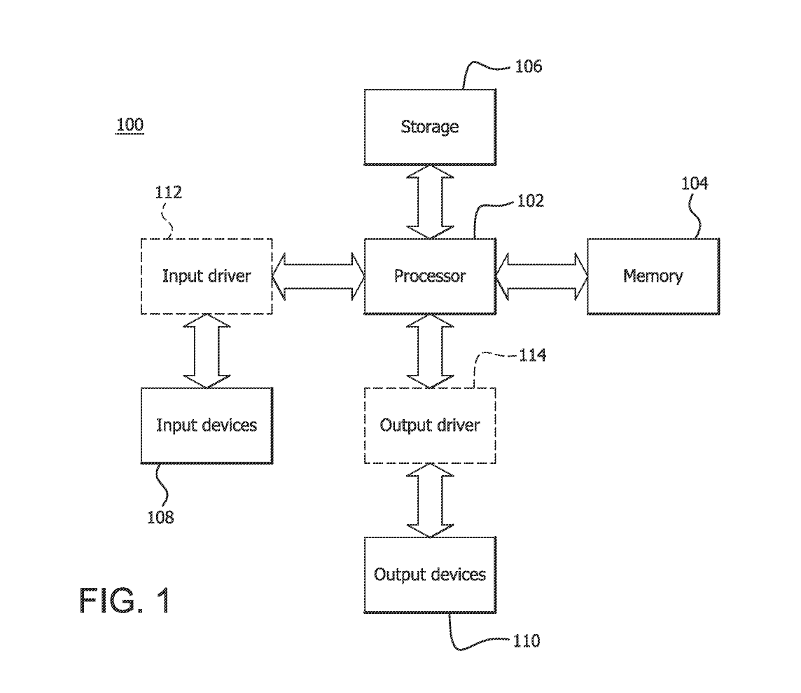

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

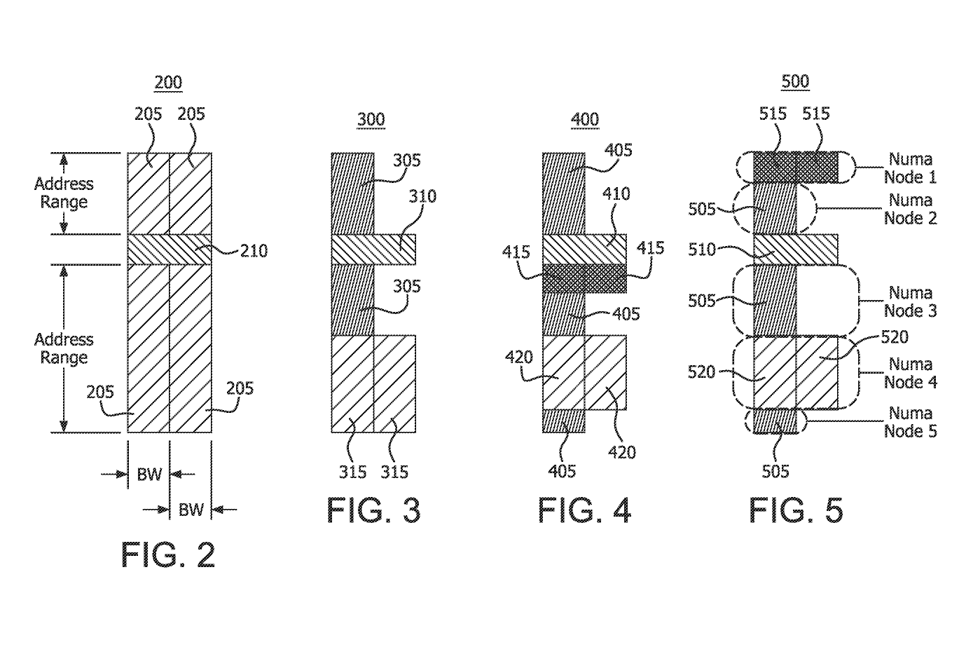

In one embodiment, a NUMA use model may be used for a single processor or SMP. For example, the NUMA use model may be used in conjunction with the processor 102 and the memory 104. In current systems, memory bandwidth may not be the same for different memory regions. FIGS. 2-7 show a memory interleaving scheme using different memory sizes.

In FIGS. 2-5, all of the memory segments shown are physical memory representing bars per memory channel. A portion of the physical memory may have a memory bandwidth that is twice as large as a single channel memory, (i.e., the bandwidth is twice as large when horizontally there are two adjacent bars shown.

FIG. 2 shows an example of a symmetric memory 200 including dual channel system memory segments 205 and a memory mapped input/output (MMIO) hole 210, (i.e., unused memory). Using FIG. 2 as an example, each memory segment 205 has an address range and a bandwidth (BW). In general, memory segments of various performance characteristics may be associated with local memory or remote memory. Further, a plurality of virtual non-uniform memory access (NUMA) nodes may be defined in system memory to represent memory segments of various performance characteristics.

FIG. 3 shows an asymmetric memory 300 without a uniform memory access (UMA). The asymmetric memory 300 includes single channel system memory 305, a MMIO hole 310 and dual channel system memory 315. The asymmetric memory 300 may be used in a system with an interleaved unganged dual channel memory.

FIG. 4 shows an asymmetric memory 400 with a UMA below a MMIO hole. The asymmetric memory 400 includes single channel system memory 405, a MMIO hole 410, interleaved UMA graphics memory 415 and dual channel system memory 420. The asymmetric memory 400 may be used in a system with an interleaved unganged dual channel memory.

FIG. 5 shows an asymmetric memory 500 with a UMA above a MMIO hole. The asymmetric memory 500 includes single channel system memory 505, a MMIO hole 510, interleaved UMA graphics memory 515 and dual channel system memory 520. The asymmetric memory 500 may be used in a system with an interleaved unganged dual channel memory.

Using FIG. 5 as an example, memory segments of various performance characteristics are allocated to memory regions of a physical memory. As shown in FIG. 5, the memory segments 515 may be represented by a first NUMA node, the memory segment 505 between the memory segments 515 and the MIMO hole 510 may be represented by a second NUMA node, the memory segment 505 between the MIMO hole 510 and memory segments 520 may be represented by a third NUMA node, the memory segments 520 may be represented by a fourth NUMA node, and the memory segment 505 below memory segments 520 may be represented by a fifth NUMA node.

In another embodiment, configurations using HBM with an ultra wide memory interface may be used to construct a portion of system memory for supporting fast HBM, and may be extended with a lower bandwidth system memory.

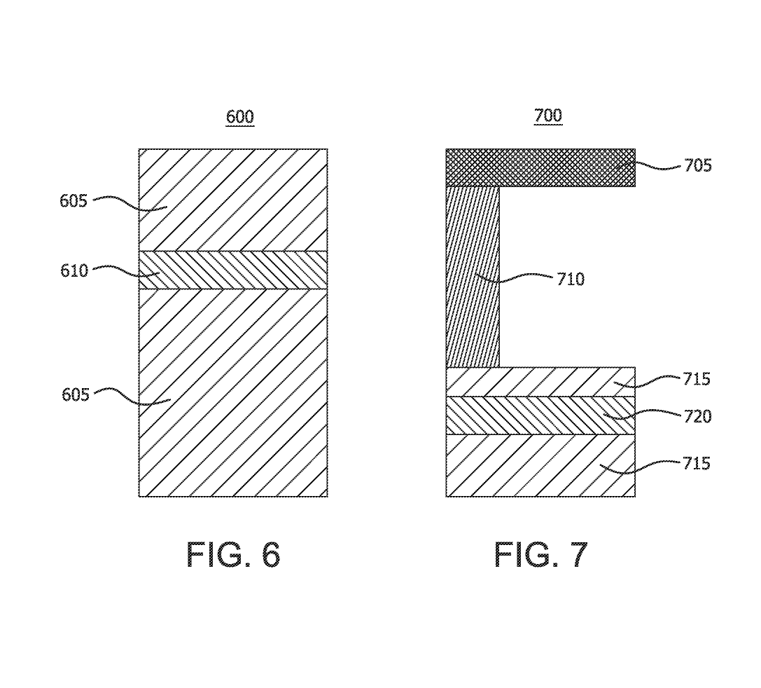

FIGS. 6 and 7 show examples of system memory mapping in accordance with some embodiments. On such systems, UMA graphics memory may be mapped to a high-bandwidth (HBM) memory region for local operation, but memory used as non-local, (i.e., remote), graphics memory or for CPU/GPU operations may be non-deterministically allocated from fast or slow memory regions, depending on the memory manager allocation strategy. There may not be any transitions, but the assignment to fast/slow memory may not take into account actual memory bandwidth requirements of each allocation. The allocation strategy may be system or OS dependent.

FIG. 6 shows a system memory 600 including HBM 605 and a MMIO hole 610. FIG. 7 shows a hybrid system memory 700 including interleaved UMA graphics memory 705 (populated from HBM), additional system memory 710, HBM system memory 715 and a MMIO hole 720. The width of the bars shown in FIGS. 6 and 7 are representative of the available bandwidth. There is high bandwidth available for the memory accesses shown in FIG. 6. However, for the hybrid system memory 700 shown in FIG. 7, some system memory regions may have different bandwidths available, whereby the additional system memory 710 is shown with a narrower bar representing a lower bandwidth than the HBM 715.

NUMA methods may be implemented to set affinity to high performance memory regions for memory speed bounded graphics, and computer and CPU operations. Using such methods, a basic input/output system (BIOS) may define two (2) virtual NUMA nodes “0” and “1”. NUMA node 0 may cover both single and dual channel memory regions and all CPU cores. NUMA node 1 may cover only a dual channel memory region(s) and all CPU cores. Software components, including but not limited to graphics driver components, may allocate memory intended for GPU operations from Node 1. Generic allocations may originate from Node 0. Application allocating memory intended to be shared with a GPU (HSA) or operations sensitive to memory bandwidth may set affinity to Node 1.

In accordance with one embodiment, a plurality of virtual NUMA-like nodes may be defined by system memory to represent memory segments of various performance characteristics, and may use node distance, which is a metric used to describe connectivity of components in a NUMA system and how far away components are in terms of interconnects, (e.g., computer buses), to indicate the performance of the memory segments. The higher the bandwidth of a memory segment, the shorter the distance from a CPU or other processing device. The virtual NUMA-like nodes may be defined for heterogeneous memory segments attached to a CPU, GPU, or any other processing device or combination thereof. The NUMA-like mechanism may be augmented by introducing additional attributes for describing the advanced topology and virtual node characteristics, as well as by extended mechanisms for querying these additional properties.

Using this approach may simplify scaling of software designs between large high performance computing (HPC) systems and smaller systems with heterogeneous memory configurations, particularly for the software that my already be relying on NUMA for high performance on multiprocessing systems.

New non-uniform memory performance (NUMP) methods for a single CPU and/or SMP are also described herein. Drivers and applications may implement these memory allocation mechanisms and allocate memory based on bandwidth requirements accordingly.

New NUMP structures may be defined for single CPU/SMP systems with NUMP which may define memory regions with different performance metrics, but may be agnostic to CPU cores. NUMA-like technology may be used to indicate available memory bandwidth for a particular memory region, rather than the CPU core affinity.

New NUMP methods may be defined and implemented to allow setting an affinity for a high or low performance NUMP region per memory allocations. Memory allocations that are not allocated through NUMP methods may not have a default affinity. The system BIOS (SBIOS), a driver or another software component may report memory regions with different performance classes. BIOS is a software component that defines system configuration and reports system capabilities and configurations to an operating system (OS). For best performance, the OS may allocate memory with default NUMP affinity from a high performance memory region, but evict it (if possible) to a low performance memory region if memory pages with affinity to high performance NUMP affinity need to be locked/paged in.

It is an optional behavior for the OS to move physical memory location while preserving the same virtual address visible to the application. Under some circumstances, the OS, (or whatever system component manages memory allocation), may decide to move less important allocations to memory with less bandwidth to make room for allocations with higher bandwidth requirements. For example, when there is a relatively small HBM system memory, all allocations and low or high priority/bandwidth requirements may be accommodated. Later, higher bandwidth that requires allocations may be created, which may displace less important allocations to memory in such a way that it is transparent to an application.

A graphics driver may allocate memory for GPU operations with high performance NUMP affinity, and generic allocations may be performed with default NUMP affinity Different allocations may have different bandwidth requirements, so that the NUMP affinity specified by a driver or application may reflect those requirements. Generally, a graphics driver has high bandwidth requirements.

Application allocating memory intended to be shared with a GPU or operations sensitive to memory bandwidth may set high performance NUMP affinity. Generally, a GPU has higher bandwidth requirements than a CPU, so any memory that will be touched by the GPU may be allocated to the NUMP with high memory bandwidth. As a side benefit for a HBM-based system low system load case, when all active memory pages reside in an HBM region, extended system memory may be constantly implemented in a self-refresh mode for power savings. When all memory allocations are in HBM system memory, additional system memory may transition to a lower power management mode, such as a self-refresh mode as an example. In an extreme case, if the OS detects that a part of memory is not being used at all, it may completely power off the unpopulated memory.

Some embodiments may provide a non-transitory computer-readable storage medium that may be configured to store a set of instructions that, when executed by at least one processor, perform a portion of a process to fabricate an integrated circuit (IC). The IC may include a plurality of virtual NUMA nodes configured to represent memory segments of various performance characteristics. The IC may further include a first memory region having memory segments represented by a first one of the NUMA nodes. A plurality of memory segments of a high-bandwidth memory (HBM) system memory may be allocated to the first memory region of the physical memory. The IC may further include a second memory region having memory segments represented by a second one of the NUMA nodes. Memory segments of system memory may be allocated to the second memory region. The IC may further include a third memory region having memory segments represented by a third one of the NUMA nodes. The memory segments of an interleaved uniform memory access (UMA) graphics memory may be allocated to the third memory region. The instructions may be Verilog data instructions, hardware description language (HDL) instructions, or software or firmware instructions.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium does not include transitory signals. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of mapping a physical memory having different memory regions, the method comprising:
defining in system memory a plurality of virtual non-uniform memory access (NUMA) nodes to represent memory segments of various performance characteristics; and
allocating memory segments of a high-bandwidth memory (HBM) system memory to a first memory region of the physical memory having memory segments represented by a first one of the NUMA nodes.

2. The method of claim 1 wherein the performance of each memory segment is based on affinity of the first NUMA node.

3. The method of claim 1 further comprising:
allocating memory segments of a system memory to a second memory region of the physical memory having memory segments represented by a second one of the NUMA nodes.

4. The method of claim 3 further comprising:
allocating memory segments of an interleaved uniform memory access (UMA) graphics memory to a third memory region of the physical memory having memory segments represented by a third one of the NUMA nodes.

5. The method of claim 3 wherein the second memory region has a higher memory bandwidth than the system memory.

6. The method of claim 1 wherein a memory region used as non-local graphics memory or for processor operations is allocated either from higher or lower memory bandwidth regions.

7. The method of claim 1 wherein the first NUMA node covers both single and dual channel memory regions.

8. The method of claim 3 wherein the second NUMA node covers at least one dual channel memory region and a plurality of central processing unit (CPU) cores.

9. A physical memory comprising;
a plurality of virtual non-uniform memory access (NUMA) nodes configured to represent memory segments of various performance characteristics; and
a first memory region having memory segments represented by a first one of the NUMA nodes, wherein a plurality of memory segments of a high-bandwidth memory (HBM) system memory are allocated to the first memory region of the physical memory.

10. The physical memory of claim 9 wherein the performance of each memory segment is based on affinity of the first NUMA node.

11. The physical memory of claim 9 further comprising:
a second memory region having memory segments represented by a second one of the NUMA nodes, wherein memory segments of system memory are allocated to the second memory region.

12. The physical memory of claim 11 further comprising:
a third memory region having memory segments represented by a third one of the NUMA nodes, wherein memory segments of an interleaved uniform memory access (UMA) graphics memory are allocated to the third memory region.

13. The physical memory of claim 11 wherein the second memory region has a higher memory bandwidth than the system memory.

14. The physical memory of claim 9 wherein a memory region used as non-local graphics memory or for processor operations is allocated either from higher or lower memory bandwidth regions.

15. The physical memory of claim 9 wherein the first NUMA node covers both single and dual channel memory regions.

16. The physical memory of claim 11 wherein the second NUMA node covers at least one dual channel memory region and a plurality of central processing unit (CPU) cores.

17. A non-transitory computer-readable storage medium configured to store a set of instructions that, when executed by at least one processor, perform a portion of a process to fabricate an integrated circuit (IC) including:
a plurality of virtual non-uniform memory access (NUMA) nodes configured to represent memory segments of various performance characteristics; and
a first memory region having memory segments represented by a first one of the NUMA nodes, wherein a plurality of memory segments of a high-bandwidth memory (HBM) system memory are allocated to the first memory region of the physical memory.

18. The non-transitory computer-readable storage medium of claim 17 wherein the IC further includes a second memory region having memory segments represented by a second one of the NUMA nodes, wherein memory segments of system memory are allocated to the second memory region.

19. The non-transitory computer-readable storage medium of claim 18 wherein the IC further includes a third memory region having memory segments represented by a third one of the NUMA nodes, wherein memory segments of an interleaved uniform memory access (UMA) graphics memory are allocated to the third memory region.

20. The non-transitory computer-readable storage medium of claim 17 wherein the instructions are hardware description language (HDL) instructions.
